(19) United States
(12) Patent Application Publication
(10) Pub. No.: US 2011/0171108 A1
(43) Pub. Date: Jul. 14, 2011

(54) MICROWAVE-ASSISTED SYNTHESIS OF NANODIAMONDS FROM TANNIN, LIGNIN, ASPHALT, AND DERIVATIVES

(75) Inventor: Tito Viswanathan, Little Rock, AR (US)

(73) Assignee: BOARD OF TRUSTEES OF THE UNIVERSITY OF ARKANSAS, Little Rock, AR (US)

(21) Appl. No.: 13/069,057

(22) Filed: Mar. 22, 2011

Related U.S. Application Data
(63) Continuation-in-part of application No. 12/487,323, filed on Jun. 18, 2009.
(60) Provisional application No. 61/132,380, filed on Jun. 18, 2008.
(60) Provisional application No. 61/316,654, filed on Mar. 23, 2010.

(51) Int. Cl. C01B 31/06; B01J 19/00; B82Y 99/00; B82Y 40/00

(52) U.S. Cl. 423/446; 204/157.43; 977/734; 977/842

(57) ABSTRACT

A method of synthesizing nanodiamonds. In one embodiment, the present invention provides a method of synthesizing nanodiamonds, which includes the step of subjecting an amount of tannin to a microwave radiation for a duration of time effective to produce a plurality of nanodiamonds.

### CROSS-REFERENCE TO RELATED PATENT APPLICATION

This application claims the benefit, pursuant to 35 U.S.C. §119(e), of U.S. provisional patent application Ser. No. 61/316,654, filed Mar. 23, 2010, entitled “MICROWAVE-ASSISTED SYNTHESIS OF NANODIAMONDS FROM TANNIN, LIGNIN, ASPHALT AND DERIVATIVES,” by Tito Viswanathan, which is incorporated herein by reference in its entirety.

This application is also a continuation-in-part of U.S. patent application Ser. No. 12/487,323, filed on Jun. 18, 2009, entitled “MICROWAVE-ASSISTED SYNTHESIS OF CARBON AND CARBON-METAL COMPOSITES FROM LIGNIN, TANNIN AND ASPHALT DERIVATIVES AND APPLICATIONS OF SAME” by Tito Viswanathan, which is incorporated herein by reference in its entirety, and itself claims the benefit, pursuant to 35 U.S.C. §119(e), of U.S. provisional patent application Ser. No. 61/132,380, filed Jun. 18, 2008, entitled “MICROWAVE-ASSISTED SYNTHESIS OF CARBON AND CARBON-METAL COMPOSITES FROM LIGNIN, TANNIN AND ASPHALT DERIVATIVES,” by Tito Viswanathan, which is incorporated herein by reference in its entirety.

This application is related to copending U.S. patent application which is filed concurrently on Mar. 22, 2011, entitled “MICROWAVE-ASSISTED SYNTHESIS OF CARBON NANOTUBES FROM TANNIN, LIGNIN, AND DERIVATIVES,” by Tito Viswanathan, which is incorporated herein by reference in its entirety, and itself claims the benefit, pursuant to 35 U.S.C. §119(e), of U.S. provisional patent application Ser. No. 61/316,682, filed on Mar. 23, 2010, entitled “MICROWAVE-ASSISTED SYNTHESIS OF CARBON NANOTUBES FROM TANNIN, LIGNIN, AND DERIVATIVES,” by Tito Viswanathan, which is incorporated herein by reference in its entirety.

Some references, which may include patents, patent applications and various publications, are cited in a reference list and discussed in the description of this invention. The citation and/or discussion of such references is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### STATEMENT OF FEDERALLY-SPONSORED RESEARCH

The present invention was made with government support under Grant No. DE-FC 36-06 GO 86072 awarded by U.S. Department of Energy (DOE). The government has certain rights in the invention.

### FIELD OF THE INVENTION

The present invention relates generally to the field of synthesis of nanodiamonds, in particular, to microwave-assisted synthesis of nanodiamonds.

### BACKGROUND

Carbon nanostructures in the form of carbon black, graphite, fullerene, single walled, double walled, multi-walled carbon nanotubes as well as nanodiamonds play a significant role in present and future technology. The applications of these nanostructures range from reinforcement in rubber tires, electrodes in batteries and fuel cells, electrostatic dissipation, electromagnetic interference shielding, photo-voltaic cells, and radar-evading stealth coatings. Specific applications of nanodiamonds is their use in nanocomposites, in electroplating baths, as lubricants and as an additive in cooling fluids. Potential applications include biocomposites and delivery of drugs. They may also serve as transparent optical material. The high surface area of nanodiamonds also renders them useful as a catalyst support material. Due to their hardness nanodiamonds may also be used in grinding media and as abrasives. They may be added to rubber tires to increase traction.

While films of nanodiamonds are attractive in terms of biocompatible coatings, the powders are poised to become one of the most important carbon forms in terms of use and applications. The synthesis of these carbon forms, however, involves substantial investment in terms of safety, cost, time, and apparatus, besides requiring expertise in instrument operation. For example, the synthesis of nanodiamond films involves a chemical vapor deposition (CVD) technique and that of nanodiamond powder involves explosive detonation of carbon-containing compounds such as trinitrotoluene (TNT) in steel chambers. There is no technique for the easy preparation of nanodiamond powders on a laboratory or an industrial scale.

Therefore, a heretofore unaddressed need exists in the art to address the aforementioned deficiencies and inadequacies.

### SUMMARY OF THE INVENTION

In one aspect, the present invention provides a method of synthesizing nanodiamonds, comprising the step of subjecting an amount of tannin to a microwave radiation for a duration of time effective to produce a plurality of nanodiamonds.

In one embodiment, the frequency of the microwave radiation is about 2.45 GHz.

In one embodiment, prior to the subjecting step, the method further comprises the steps of (a) placing the amount of tannin in a first container, and (b) placing the first container with the amount of tannin in a second container that contains graphite or carbon black.

In one embodiment, the step of subjecting comprises the step of subjecting the amount of the tannin placed in the first container to the microwave radiation, wherein the first container is placed in the second container, which is positioned such that at least part of the graphite or carbon black contained in the second container is also subjected to the microwave radiation.

In one embodiment, the tannin is unmodified and hot water-soluble Quebracho tannin.

In another aspect, the present invention provides an article of manufacture made by the method set forth immediately above.

In another aspect, the present invention provides a method of synthesizing nanodiamonds, comprising the step of subjecting an amount of material selected from the group consisting of lignin, tannin, lignosulfonate, tanninsulfonate, and a mixture of thereof to a microwave radiation for a first duration of time effective to produce a sample containing a plurality of nanodiamonds.

In one embodiment, the method further comprises the steps of (a) after the subjecting step, mixing the sample with water to obtain a solution, (b) heating the solution to a first temperature for a second duration of time, and (c) cooling the solution at a second temperature that is lower than the first temperature.

In one embodiment, the first temperature is corresponding to the boiling point of the solution, and the second temperature is room temperature.

In one embodiment, the first duration of time is less than 20 minutes for about 1 g of the material, and the second duration of time is same or different from the first duration of time.

In one embodiment, prior to the subjecting step, the method further comprising the steps of (a1) placing the amount of material in a first container, and (a2) placing the first container with the amount of the material in a second container.

In one embodiment, the frequency of the microwave radiation is about 2.45 GHz.

In another aspect, the present invention provides an article of manufacture made by the method set forth immediately above.

In yet another aspect, the present invention provides a method of synthesizing nanodiamonds, comprising the steps of (a) mixing a first amount of tannin with a second amount of sodium perborate (NaBO₃) to obtain a mixture, and (b) subjecting the mixture to a microwave radiation for a first duration of time effective to produce a sample containing a plurality of nanodiamonds.

In one embodiment, prior to the subjecting step, the method further comprises the steps of (a1) placing the mixture in a first container, and (a2) placing the first container with the mixture in a second container that contains graphite or carbon black.

In one embodiment, the step of subjecting comprises the step of subjecting the mixture placed in the first container to the microwave radiation, wherein the first container is placed in the second container, which is positioned such that at least part of the graphite or carbon black contained in the second container is also subjected to the microwave radiation.

In one embodiment, the frequency of the microwave radiation is about 2.45 GHz.

In one embodiment, the tannin is unmodified and hot water-soluble Quebracho tannin.

In one embodiment, the method further comprises the steps of (b1) after the subjecting step, mixing the sample with water to obtain a solution, and (b2) heating the solution to a temperature corresponding to the boiling point of the solution for a second duration of time.

In one embodiment, for about 1 g of tannin and about 0.1 g of sodium perborate and the power of the microwave radiation about 650 Watt, wherein the first duration of time is about 4 minutes.

In one embodiment, the second duration of time is different from the first duration of time.

In a further aspect, the present invention provides an article of manufacture made by the method set forth immediately above.

These and other aspects of the present invention will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The drawings described below are for illustration purposes only. The drawings are not intended to limit the scope of the present teachings in any way. The patent or application file may contain at least one drawing executed in color. If so, copies of this patent or patent application publication with color drawing(s) will be provided by the Office upon request and payment of the necessary fee.

FIG. 1 shows a reaction scheme for the sulfonation of a monomeric unit of a condensed tannin.

FIG. 2 shows a typical sulfonated/sulfomethylated lignin monomer unit.

FIG. 3 shows a schematic drawing of the experimental setup 300 in Example 1 in the detailed description according to one embodiment of the present invention.

FIG. 4 shows a schematic drawing of the experimental setup 400 in Example 2 in the detailed description according to one embodiment of the present invention.

FIG. 5 shows a schematic drawing of the experimental setup 500 in Example 3 in the detailed description according to one embodiment of the present invention.

FIG. 6 shows an XRD pattern of carbon obtained from microwaving tannin according to one embodiment of the present invention.

FIG. 7 shows an XRD pattern of carbon obtained from microwaving lignin according to one embodiment of the present invention.

FIG. 8 shows an XRD pattern for a carbon-nickel composite synthesized by microwaving a tannin-nickel complex according to one embodiment of the present invention.

FIG. 9 shows a Raman spectrum of carbon produced from microwaving tannin (without added carbon) according to one embodiment of the present invention.

FIG. 10 shows a Raman spectrum of carbon produced from microwaving tannin (without added carbon) according to one embodiment of the present invention.

FIG. 11 shows a Raman spectrum of lignin produced from microwaving lignin (without added carbon) according to one embodiment of the present invention.

FIG. 12 shows a Raman spectrum of lignin produced from microwaving lignin (without added carbon) according to one embodiment of the present invention.

FIG. 13 shows a Raman spectrum of carbon produced from tannin-formaldehyde condensation product (no carbon added) according to one embodiment of the present invention.

FIG. 14 shows a Raman spectrum of carbon produced from tannin-formaldehyde condensation product (no carbon added) according to one embodiment of the present invention.

FIG. 15 shows a Raman spectrum of carbon composite prepared by microwaving nickel-tannin composite (no carbon added) according to one embodiment of the present invention.

FIG. 16 shows a Raman spectrum of carbon composite prepared by microwaving nickel-tannin composite (no carbon added) according to one embodiment of the present invention.

FIG. 17 shows a Raman spectrum of carbon composite prepared by microwaving iron (III)-lignosulfonate (no carbon added) according to one embodiment of the present invention.

FIG. 18 shows a Raman spectrum of carbon composite prepared by microwaving iron (III)-lignosulfonate (no carbon added) according to one embodiment of the present invention.

### DETAILED DESCRIPTION

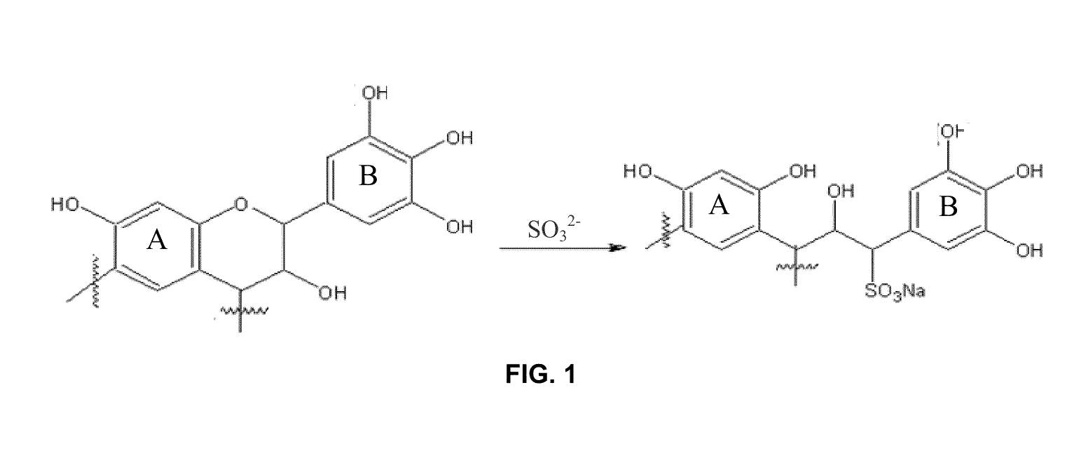

The present invention is more particularly described in the following examples that are intended as illustrative only since numerous modifications and variations therein will be apparent to those skilled in the art. Various embodiments of the invention are now described in detail. Referring to the drawings, FIGS. 1-18, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention. Additionally, some terms used in this specification are more specifically defined below.

### Definitions

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “X-ray diffraction (XRD)” refers to one of X-ray scattering techniques that are a family of non-destructive analytical techniques which reveal information about the crystallographic structure, chemical composition, and physical properties of materials and thin films. These techniques are based on observing the scattered intensity of an X-ray beam hitting a sample as a function of incident and scattered angle, polarization, and wavelength or energy. In particular, X-ray diffraction finds the geometry or shape of a molecule, compound, or material using X-rays. X-ray diffraction techniques are based on the elastic scattering of X-rays from structures that have long range order. The most comprehensive description of scattering from crystals is given by the dynamical theory of diffraction.

As used herein, the term “Raman spectroscopy” or “Raman techniue” refers to an optical technique that probes the specific molecular content of a sample by collecting in-elastically scattered light. As photons propagate through a medium, they undergo both absorptive and scattering events. In absorption, the energy of the photons is completely transferred to the material, allowing either heat transfer (internal conversion) or re-emission phenomena such as fluorescence and phosphorescence to occur. Scattering, however, is normally an in-elastic process, in which the incident photons retain their energy. In Raman scattering, the photons either donate or acquire energy from the medium, on a molecular level. In contrast to fluorescence, where the energy transfers are on the order of the electronic bandgaps, the energy transfers associated with Raman scattering are on the order of the vibrational modes of the molecule. These vibrational modes are molecularly specific, giving every molecule a unique Raman spectral signature.

Raman scattering is a very weak phenomena, and therefore practical measurement of Raman spectra of a medium requires high power excitation laser sources and extremely sensitive detection hardware. Even with these components, the Raman spectra from tissue are masked by the relatively intense tissue auto-fluorescence. After detection, post processing techniques are required to subtract the fluorescent background and enable accurate visualization of the Raman spectra. Raman spectra are plotted as a function of frequency shift in units of wavenumber (cm⁻¹). The region of the Raman spectra where most biological molecules have Raman peaks is from 500 to 2000 cm⁻¹. In contrast to fluorescence spectra, Raman spectra have sharp spectral features that enable easier identification of the constituent sources of spectral peaks in a complex sample.

As used herein, “nanoscopic-scale,” “nanoscopic,” “nanometer-scale,” “nanoscale,” “nanocomposites,” “nanoparticles,” the “nano-” prefix, and the like generally refers to elements or articles having widths or diameters of less than about 1 μm, preferably less than about 100 nm in some cases. In all embodiments, specified widths can be smallest width (i.e. a width as specified where, at that location, the article can have a larger width in a different dimension), or largest width (i.e. where, at that location, the article's width is no wider than as specified, but can have a length that is greater).

As used herein, “carbon nanostructures” refer to carbon fibers or carbon nanotubes that have a diameter of 1 μm or smaller which is finer than that of carbon fibers. However, there is no particularly definite boundary between carbon fibers and carbon nanotubes. By a narrow definition, the material whose carbon faces with hexagon meshes are almost parallel to the axis of the corresponding carbon tube is called a carbon nanotube, and even a variant of the carbon nanotube, around which amorphous carbon exists, is included in the carbon nanotube.

As used herein, “plurality” means two or more.

As used herein, the terms “comprising,” “including,” “carrying,” “having,” “containing,” “involving,” and the like are to be understood to be open-ended, i.e., to mean including but not limited to.

### OVERVIEW OF THE INVENTION

The present invention provides, among other things, an innovative method of synthesizing microdiamonds assisted by microwave radiation, using lignins, tannins, lignosulfonates, tanninsulfonates and their metal salts as starting materials.

Carbon nanostructures in the form of carbon black, graphite, fullerene, single walled, double walled, multi-walled carbon nanotubes as well as nanodiamonds play a significant role in present and future technology. The applications of these nanostructures range from reinforcement in rubber tires, electrodes in batteries and fuel cells, electrostatic dissipation, electromagnetic interference shielding, photo-voltaic cells, and radar-evading stealth coatings. Specific applications of nanodiamonds is their use in nanocomposites, in electroplating baths, as lubricants and as an additive in cooling fluids. Potential applications include biocomposites and delivery of drugs. They may also serve as transparent optical material. The high surface area of nanodiamonds also renders them useful as a catalyst support material. Due to their hardness nanodiamonds may also be used in grinding media and as abrasives. They may be added to rubber tires to increase traction. The synthesis of these carbon forms involves substantial investment in terms of safety, cost, time, and apparatus, besides requiring expertise in instrument operation. For example, the synthesis of nanodiamond films involves a chemical vapor deposition (CVD) technique and that of nanodiamond powder involves explosive detonation of carbon-containing compounds such as trinitrotoluene (TNT) in steel chambers. There is no technique for the easy preparation of nanodiamond powders on a laboratory or an industrial scale. While films of nanodiamonds are attractive in terms of biocompatible coatings, the powders are poised to become one of the most important carbon forms in terms of use and applications.

The use of microwave for preparing nanomaterials should be considered a greener method for the synthesis of the nanostructures due to savings in terms of cost, time, and investment. This project enables the preparation of carbon nanostructures including nanodiamonds using a simplified yet innovative microwave-assisted synthesis, using lignins, tannins, lignosulfonates, tanninsulfonates, and their metal salts as starting materials.

### Tannin and Sources

Tannins are naturally occurring polyphenols that are found in the vascular tissue of plants such as the leaves, bark, grasses, and flowers. They are classified into two groups: condensed tannins and hydrolysable tannins. FIG. 1 illustrates the reaction scheme for the sulfonation of monomeric unit of a condensed tannin. The structure consists of three rings: two benzene rings on either side of an oxygen-containing heterocyclic ring. The A-ring to the left of the cyclic ether ring consists of one or two hydroxyl groups. The B-ring present on the right of the cyclic ether ring also consists of two or three hydroxyl groups.

A particular tannin of interest is Quebracho tannin. This tannin is obtained from the hot water extraction of the heartwoods of Schinopsis balansae and lorentzii, indigenous to Argentina and Paraguay. Quebracho accounts for 30% of the dry weight of the heartwoods with a production level averaging 177,000 tons per year over the past 30 years, according to the Tannin Corporation, Peabody, Mass. In addition to unmodified hot water-soluble tannins, cold water soluble sulfonated tannins are commercially available and represent an inexpensive renewable resource. For example, Chevron Philips Company in Bartlesville, Okla. supplies tannins with different degrees of sulfonation. The MSDSs and technical data sheets providing the structure and percentage of sulfur in the products are also provided. Sold under the trade name of “Orform” tannins, these represent an alternate source of a sulfonated renewable resource that could be compared to sulfonated lignins.

### Lignin and Sources

Lignin, the major non-cellulosic constituent of wood, is a complex phenolic polymer that bears a superficial resemblance to phenol-formaldehyde resins. It consists of functionalized phenylpropane units connected via alkyl and aryl ether linkages. Essentially, all of the lignin commercially available is isolated as by-products from the paper industry from either the sulfite or the Kraft process .

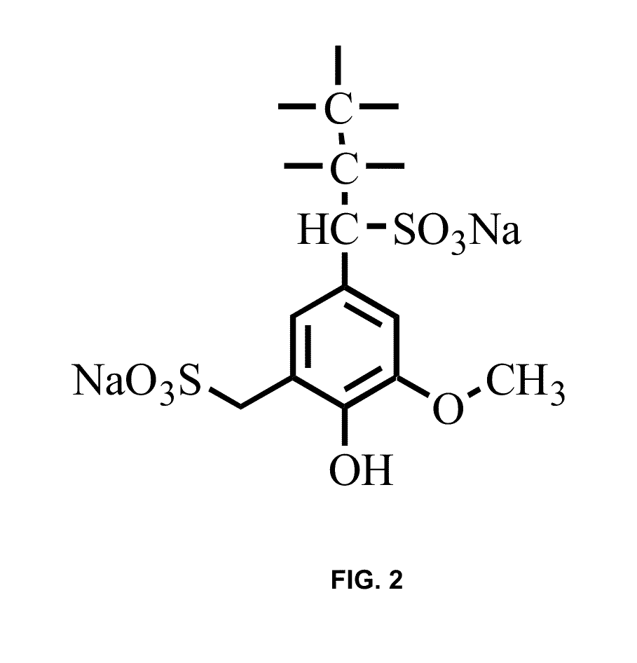

Sulfonated lignins are obtained either as spent sulfite liquor (SSL) or by sulfonation of lignin obtained from the Kraft process. SSL obtained from the sulfite process consists of lignosulfonates (about 55%), sugars (30%), and other ingredients in smaller amounts. FIG. 2 shows a typical monomeric unit of Kraft lignin that has been sulfomethylated at the aromatic ring and sulfonated on the aliphatic side chain. Sulfomethylation is accomplished by the reaction of the Kraft lignin with formaldehyde and sodium sulfite. The aliphatic sulfonation occurs preferentially at the benzylic position of the side chain of the phenylpropane units. Lignosulfonates are available in the form of calcium or sodium salts (Borasperse® and Ultrazine® from Mead Westvaco, for example) and are cheaper alternatives to other forms of lignosulfonates. Lignotech's calcium salt of lignosulfonic acid [Borresperse-CA] is especially suitable for the synthesis of metal-carbon nanocomposites. Some of the applications of lignosulfonates are in concrete admixtures, animal feed, oil-well drilling mud, dust control, emulsion stabilizers, dye dispersants, wood preservation, and mining aids. Almost a million metric tones of lignosulfonate is produced every year and the major manufacturers and their annual production is published.

Mead Westvaco and LignoTech USA are two of the major manufacturers of lignosulfonates in the U.S. and a variety of sulfonated lignin products are available from them. The sulfonation can be controlled to occur either at the aromatic ring or the benzylic position or both. The degree and position of sulfonation can affect the final property and potential application of the lignin.

### Asphalt, Sulfonated Asphalt and Asphaltenes

Sulfonated asphalts are used extensively in the petroleum industry. They are produced by the sulfonation of asphalt which is derived from petroleum. Asphalts are residues obtained during the purification of petroleum. They represent a complex mixture of low and high molecular weight aromatics and alkanes. Addition of low molecular weight alkanes such as pentane, hexane or heptane results in the dissolution of most of the hydrocarbons in asphalt leaving behind a residue of high molecular weight substituted aromatics collectively called “asphaltenes”. The structure of asphaltene is quite complicated but generally consists of high molecular weight polycyclic hydrocarbons with alkyl substituents. It also has a small but varying percentage of S and N in its structure. The asphaltene content in asphalt may vary from 5 to 10% or more.

Thus, in one aspect, the present invention provides a method of synthesizing nanodiamonds, comprising the step of subjecting an amount of tannin to a microwave radiation for a duration of time effective to produce a plurality of nanodiamonds.

In one embodiment, the frequency of the microwave radiation is about 2.45 GHz.

In one embodiment, prior to the subjecting step, the method further comprises the steps of (a) placing the amount of tannin 312 in a first container 310, and (b) placing the first container 310 with the amount of tannin 312 in a second container 320 that contains graphite or carbon black 322.

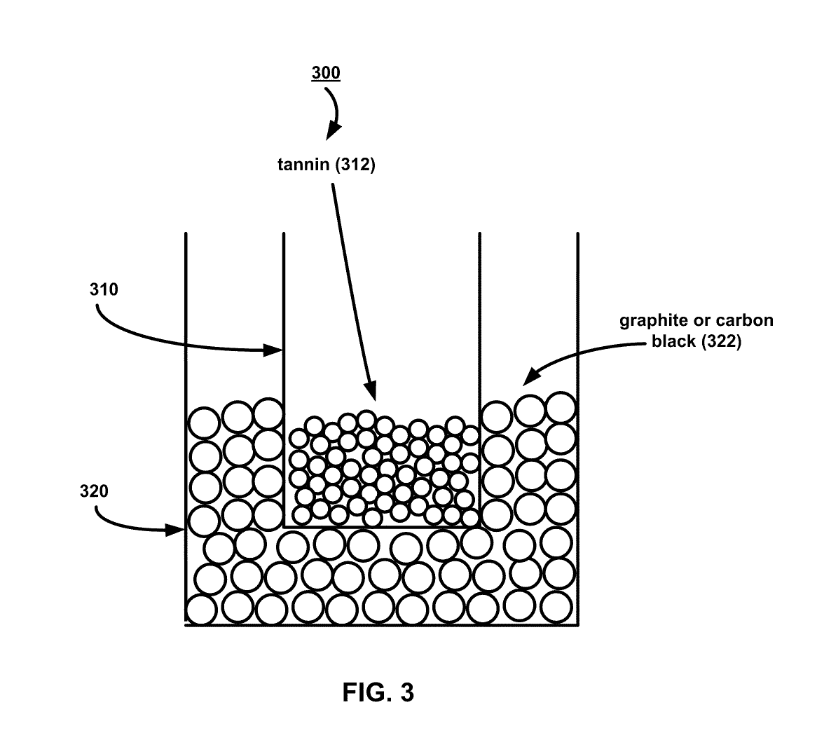

In one embodiment as shown in FIG. 3, the step of subjecting comprises the step of subjecting the amount of the tannin 312 placed in the first container 310 to the microwave radiation (not shown), wherein the first container 310 is placed in the second container 320, which is positioned such that at least part of the graphite or carbon black 322 contained in the second container 320 is also subjected to the microwave radiation (not shown).

In one embodiment, the tannin is unmodified and hot water-soluble Quebracho tannin.

In another aspect, the present invention provides an article of manufacture made by the method set forth immediately above.

In another aspect, the present invention provides a method of synthesizing nanodiamonds, comprising the step of subjecting an amount of material selected from the group consisting of lignin, tannin, lignosulfonate, tanninsulfonate, and a mixture of thereof to a microwave radiation for a first duration of time effective to produce a sample containing a plurality of nanodiamonds.

In one embodiment, the method further comprises the steps of (a) after the subjecting step, mixing the sample with water to obtain a solution, (b) heating the solution to a first temperature for a second duration of time, and (c) cooling the solution at a second temperature that is lower than the first temperature.

In one embodiment, the first temperature is corresponding to the boiling point of the solution, and the second temperature is room temperature.

In one embodiment, the first duration of time is less than 20 minutes for about 1 g of the material, and the second duration of time is same or different from the first duration of time.

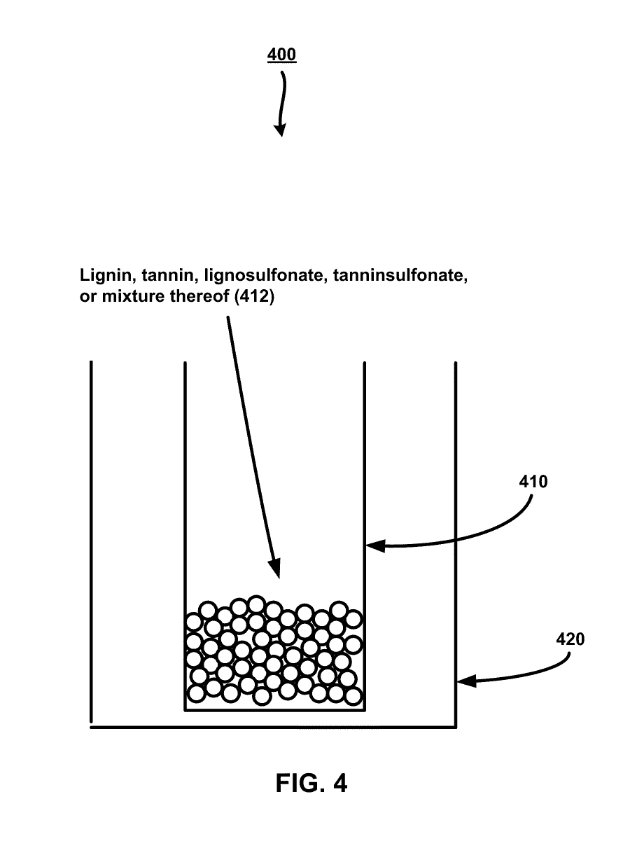

In one embodiment as shown in FIG. 4, prior to the subjecting step, the method further comprising the steps of (a1) placing the amount of material 412 in a first container 410, and (a2) placing the first container 410 with the amount of the material 412 in a second container 420.

In one embodiment, the frequency of the microwave radiation is about 2.45 GHz.

In another aspect, the present invention provides an article of manufacture made by the method set forth immediately above.

In yet another aspect, the present invention provides a method of synthesizing nanodiamonds, comprising the steps of (a) mixing a first amount of tannin with a second amount of sodium perborate (NaBO₃) to obtain a mixture, and (b) subjecting the mixture to a microwave radiation for a first duration of time effective to produce a sample containing a plurality of nanodiamonds.

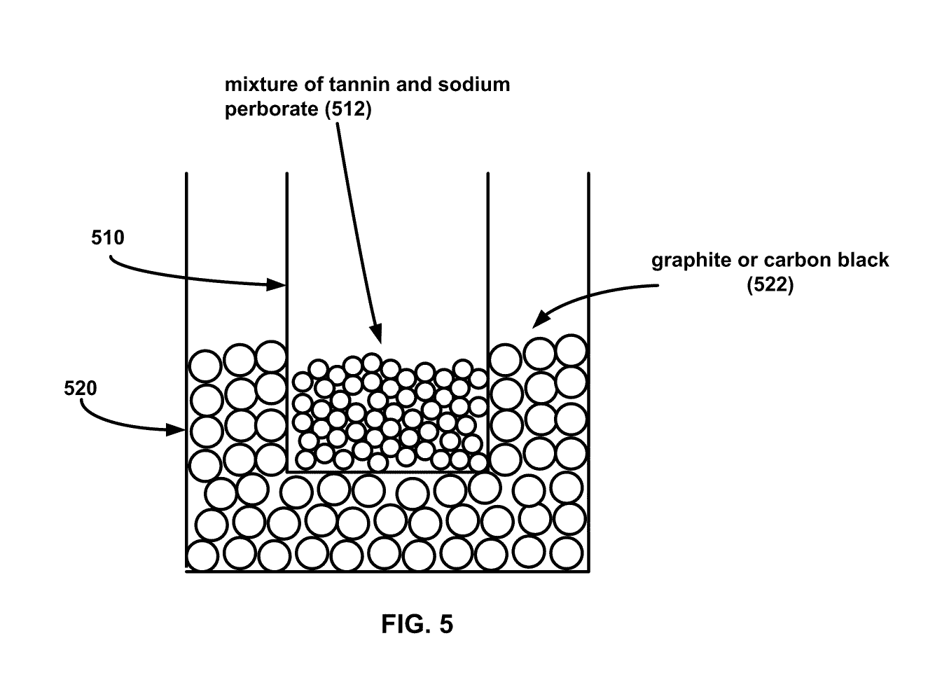

In one embodiment as shown in FIG. 5, prior to the subjecting step, the method further comprises the steps of (a1) placing the mixture 512 in a first container 510, and (a2) placing the first container 510 with the mixture 512 in a second container 520 that contains graphite or carbon black 522.

In one embodiment, the step of subjecting comprises the step of subjecting the mixture 512 placed in the first container 510 to the microwave radiation (not shown), wherein the first container 510 is placed in the second container 520, which is positioned such that at least part of the graphite or carbon black 522 contained in the second container 520 is also subjected to the microwave radiation (not shown).

In one embodiment, the frequency of the microwave radiation is about 2.45 GHz.

In one embodiment, the tannin is unmodified and hot water-soluble Quebracho tannin.

In one embodiment, the method further comprises the steps of (b1) after the subjecting step, mixing the sample with water to obtain a solution, and (b2) heating the solution to a temperature corresponding to the boiling point of the solution for a second duration of time.

In one embodiment, for about 1 g of tannin and about 0.1 g of sodium perborate and the power of the microwave radiation about 650 Watt, wherein the first duration of time is about 4 minutes.

In one embodiment, the second duration of time is different from the first duration of time.

In a further aspect, the present invention provides an article of manufacture made by the method set forth immediately above.

Additional details are set forth below.

### EXAMPLES

Aspects of the present teachings may be further understood in light of the following examples, which should not be construed as limiting the scope of the present teachings in any way.

### Example 1

A dry one gram sample 312 of unmodified tannin (Quebracho, hot water soluble) was subjected to microwave in a suitable container 310 placed in another container 320 containing dry graphite or carbon black powder 322, as shown schematically in FIG. 3. The graphite or carbon black powder assisted in the heating of the tannin powder. The microwave frequency used was a domestic microwave oven operating at 2.45 GHz with 900 Watt power, in which the entire said assembly 300 was placed under the hood. The oven was then turned on. The outer carbon sample got red hot within ten seconds after turning on the microwave oven and the tannin in the reaction vessel started to liberate smoke within a minute. The reaction was carried out for a total of 4 minutes during which the smoke from the sample had subsided. The black sample was powdered and optionally washed with water and then dried.

### Example 2

In an alternate preparation a 1 gram powder 412 of lignin, tannin, lignosulfonate or tanninsulfonate or mixtures thereof, is placed in a test tube 410, and the test tube 410 is placed vertically inside a beaker 420, as shown schematically in FIG. 4. The entire said assembly 400 is placed inside a microwave-oven under the hood and the oven is then turned on. The sample turns red after a couple of minutes, and then glows during the entire process. The sample is heated further for another 4 minutes. The black sample is then powdered using a mortar and pestle and then introduced in a Erlenmeyer flask. A 100 mL aliquot of deionized (DI) water is brought to boil while stirring. The solution is then cooled to room temperature and filtered through a coarse filter paper. Residue is washed with 4×100 mL of DI water and then dried on the filter paper via suction. It is then dried further in a vacuum oven at room temperature overnight.

### Example 3

In another embodiment, to 1 g of powdered tannin a 0.1 g sample of sodium perborate is added and mixed thoroughly using a mortar and pestle to form a mixture 512. It is then subjected to microwave radiation in a test tube 510 placed in another vessel 520 with carbon black or graphite 522, as shown schematically in FIG. 5, using a 2.45 GHz, 650 Watt microwave oven placed under a hood. The sample is subjected to 4 minutes of microwave treatment. The sample is cooled and introduced into a mortar and pestle and powdered. The sample is treated in 200 mL boiling water for 10 minutes and cooled and filtered through suction. It is then washed with 4×100 mL of DI water and dried on the filter paper under suction. It is further dried in a vacuum oven in room temperature overnight.

### Example 4

This example describes nanodiamonds that are synthesized according to one embodiment of the present invention utilizing the exemplary process set forth in Example 1, or a process similar to it.

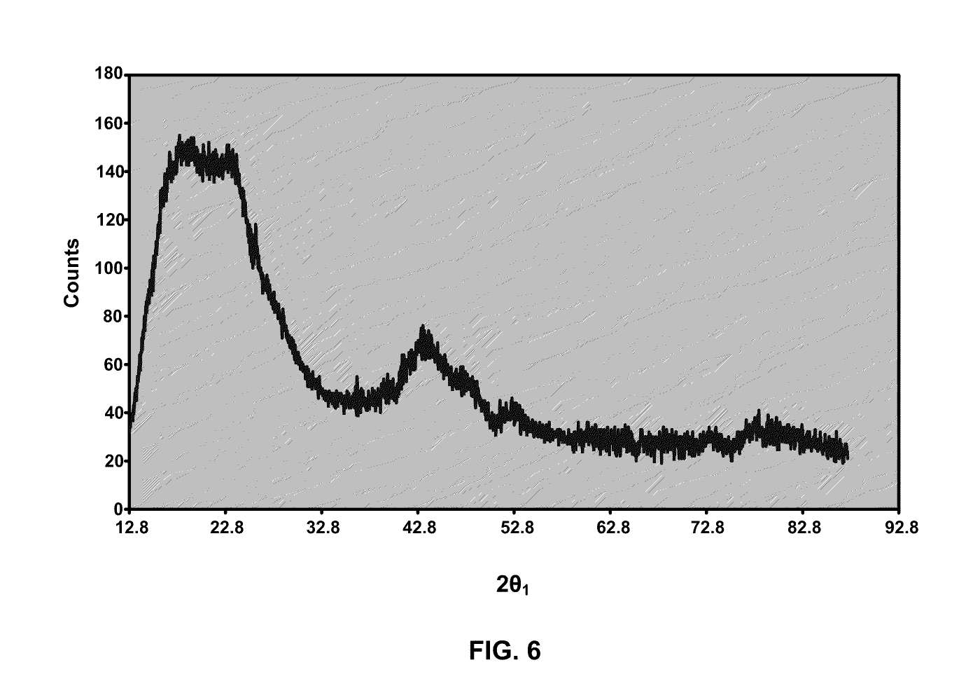

FIG. 6 shows an XRD pattern of carbon obtained from microwaving tannin. Distinctive peaks in the XRD pattern are composed of a broad diffraction peak centered at about 20° 2θ (with a range of 17° and 22°) and another broad peak centered at about 44° 2θ. The peak around 44° is due to nanodiamond. If the maximum intensity of the broad peak at about 20° is at 170 counts, the intensity of the peak at about 44° 2θ is about 70 counts.

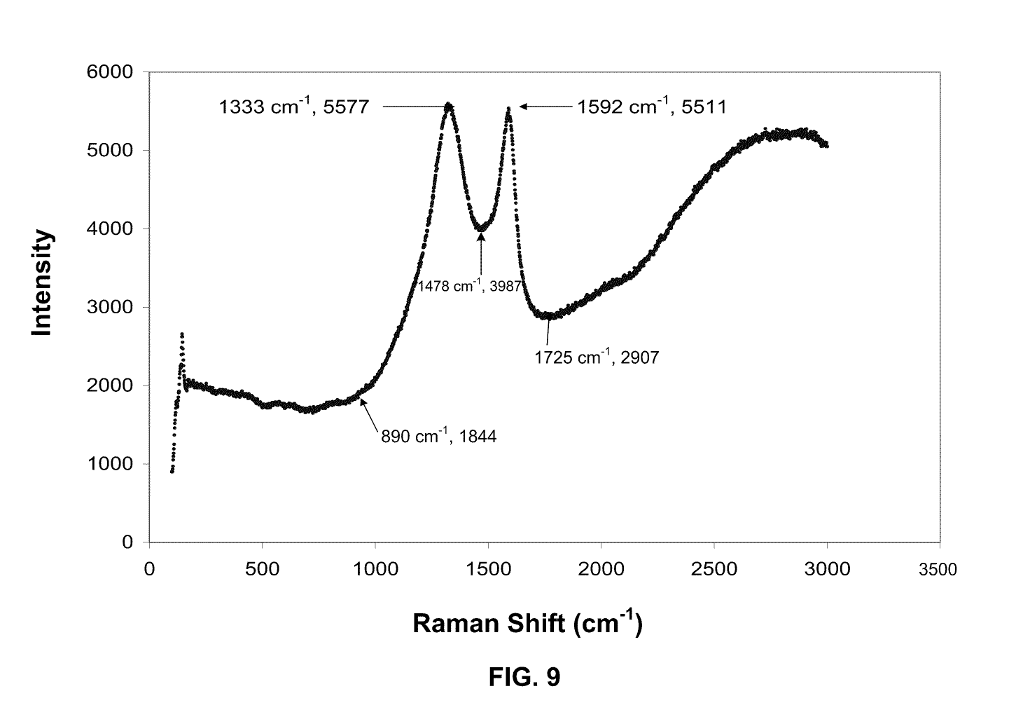

FIG. 9 shows a typical Raman spectroscopic data of carbon produced according to one embodiment of the present invention from tannin (in the absence of metal atoms or added carbon). The Raman spectrum shows a peak at 1592 cm⁻¹ which represents the G-band (carbon with a graphitic nature) due to the E_{2g} mode (stretching) related to the sp² carbons. The peak centered at 1333 cm⁻¹ may be due to nanodiamond in addition to A_{1g} mode (breathing mode) of sp² carbons in ring. The broad peak that shows a maximum around 2700 cm⁻¹ may be ascribed to the first overtone of the band centered at 1333 cm⁻¹. The Raman spectrum shows that a unique form of carbon is being produced by a method of the present invention.

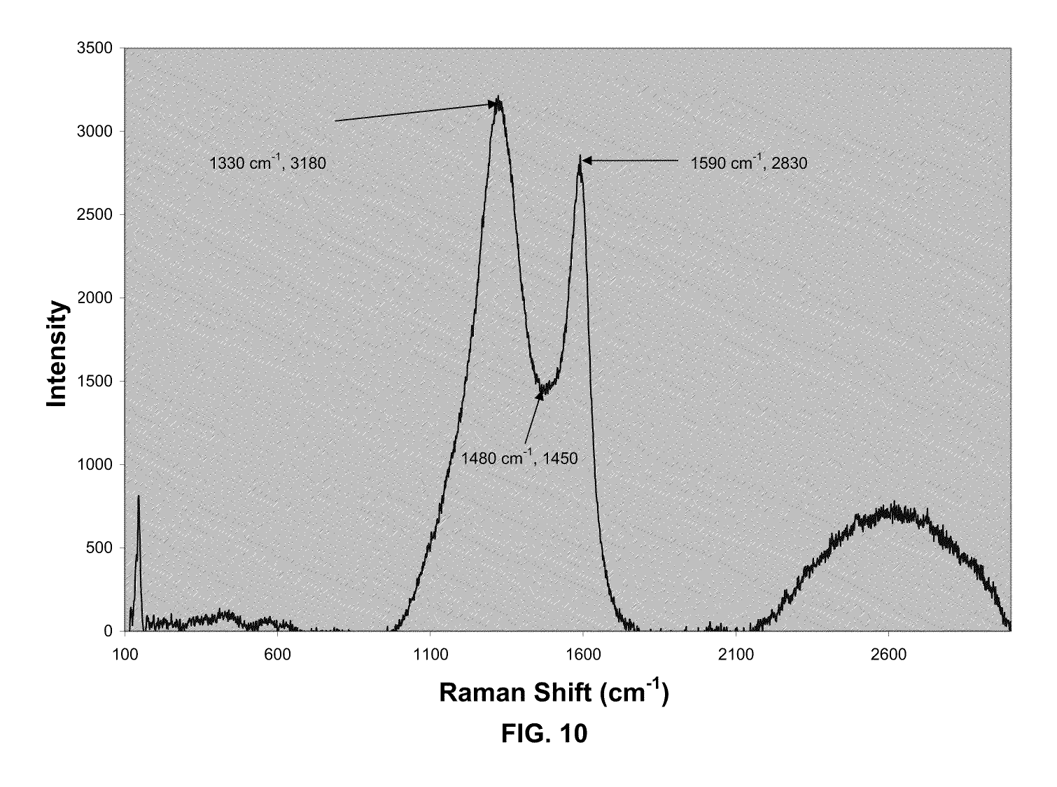

FIG. 10 shows a typical Raman spectroscopic data of carbon produced according to one embodiment of the present invention from tannin (in the absence of metal atoms or added carbon). The baseline corrected Raman spectrum shows a peak at 1590 cm⁻¹ which represents the G-band (carbon with a graphitic nature) due to the E_{2g} mode (stretching) related to the sp² carbons. The diffuse band (D-band) occurs around 1330 cm⁻¹ and represents the A_{1g} mode (breathing) as well as C atoms designated as nanodiamond. The broad peak that shows a maximum around 2700 cm⁻¹ may be ascribed to the first overtone of the D band. The Raman spectrum shows that a unique form of carbon is being produced by a method of the present invention.

### Example 5

This example describes nanodiamonds that are synthesized according to one embodiment of the present invention utilizing the exemplary process set forth in Example 2, or a process similar to it.

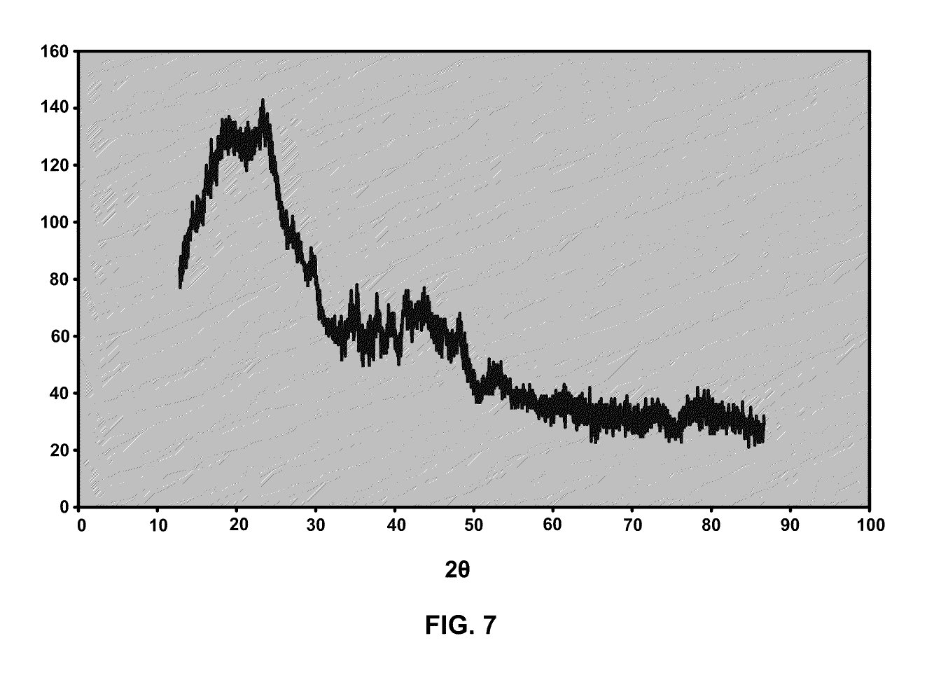

FIG. 7 shows an XRD pattern of carbon obtained from microwaving lignin. Distinctive peaks in the XRD pattern are composed of a broad diffraction peak centered at about 21° 2θ (with a range of 18° and 24°) and another broad peak centered at about 44° 2θ. The peak centered around 44° is due to nanodiamond. If the maximum intensity of the broad peak at about 20° is at 134 counts, the intensity of the peak at about 44° 2θ is about 70 counts.

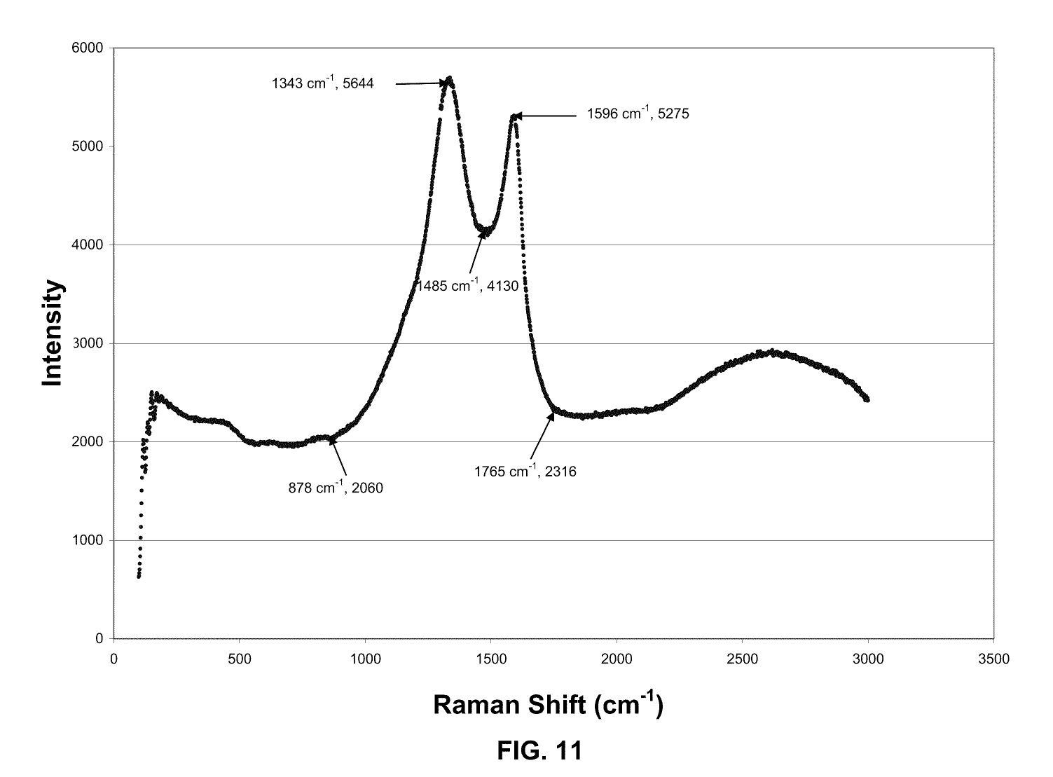

FIG. 11 shows a typical Raman spectroscopic data of carbon produced according to another embodiment of the present invention from sodium salt of lignin (in the absence of metal atoms or added carbon). The Raman spectrum shows a peak at 1596 cm⁻¹ which represents the G-band (graphite) is due to the E_{2g} mode (stretching) related to the sp² carbons. The diffuse band (D-band) occurs around 1343 cm⁻¹ and represents the A_{1g} mode (breathing) and may be associated with C atoms in nanodiamond. The broad peak that shows a maximum around 2700 cm⁻¹ may be ascribed to the first overtone of the D band. The Raman spectrum shows that carbon is being produced by a method of the present invention.

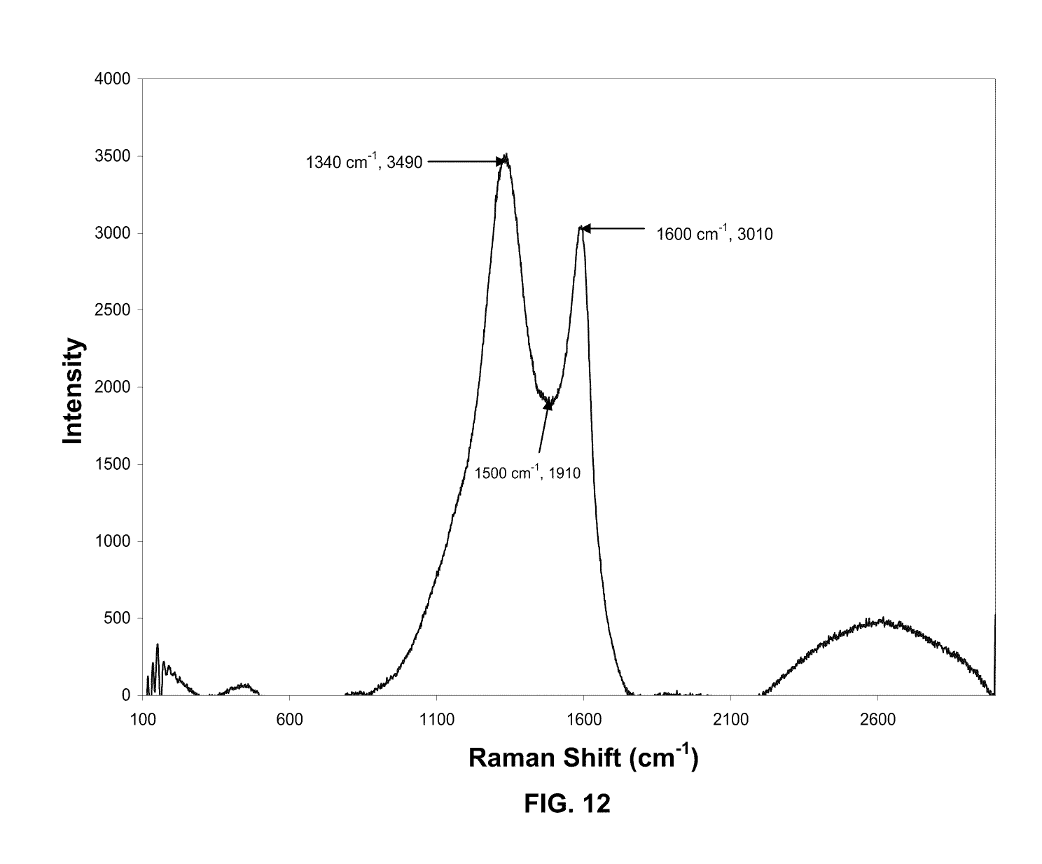

FIG. 12 shows a typical Raman spectroscopic data of carbon produced according to another embodiment of the present invention from sodium salt of lignin (in the absence of metal atoms or added carbon). The baseline corrected Raman spectrum shows a peak at 1600 cm⁻¹ which represents the G-band (graphite) is due to the E_{2g} mode (stretching) related to the sp² carbons. The diffuse band (D-band) occurs around 1340 cm⁻¹ and represents the A_{1g} mode (breathing) and may be associated with C atoms in nanodiamond. The broad peak that shows a maximum around 2700 cm⁻¹ may be ascribed to the first overtone of the D band. The Raman spectrum shows that a unique carbon nanostructure is being produced by a method of the present invention.

### Example 6

This example describes nanodiamonds that are synthesized by microwaving a tannin-nickel complex, according to one embodiment of the present invention.

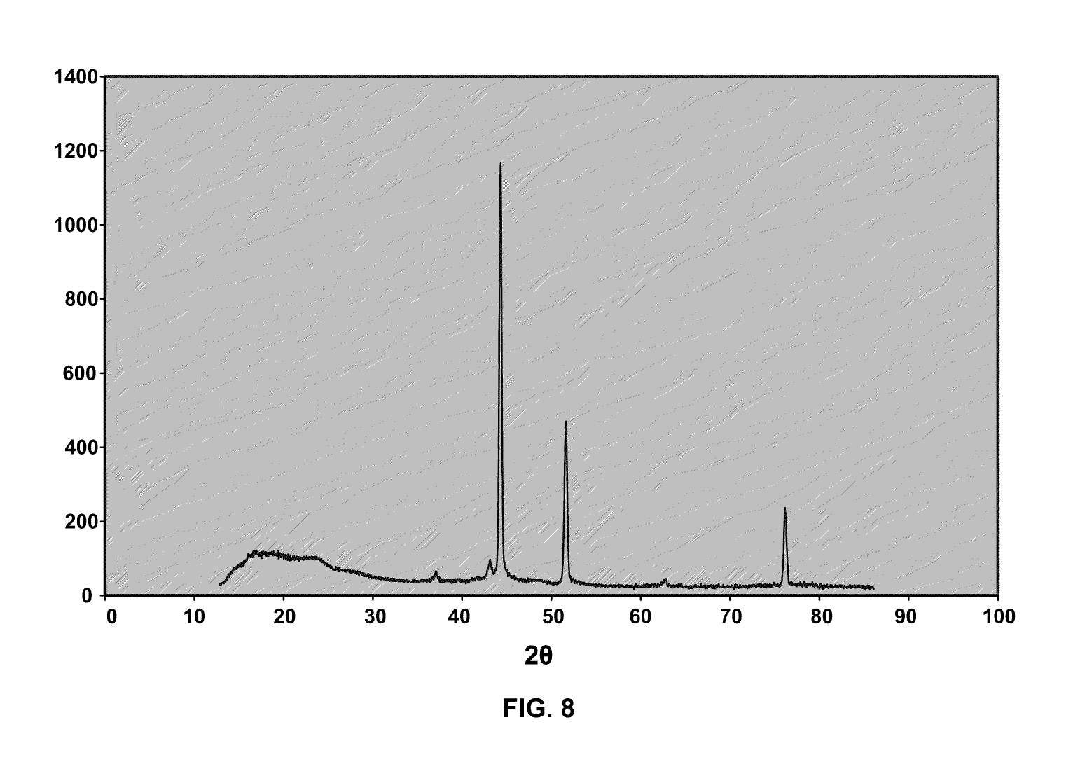

FIG. 8 shows an XRD pattern for a carbon-nickel composite synthesized by microwaving a tannin-nickel complex. The XRD pattern consists of a broad diffraction peak centered at about 21° 2θ (with a range of 17° and 24°) and other peaks centered at about 37.4 and 43.2° 2θ. The peak at 43.2° is due to nanodiamond. If the maximum intensity of the broad peak at about 21° is at 110 counts the intensity of the peak at about 43° 2θ is about 88°. Sharp peaks at about 45°, about 52° and about 76° 2θ values represent several peaks due to nickel nanoparticles, respectively.

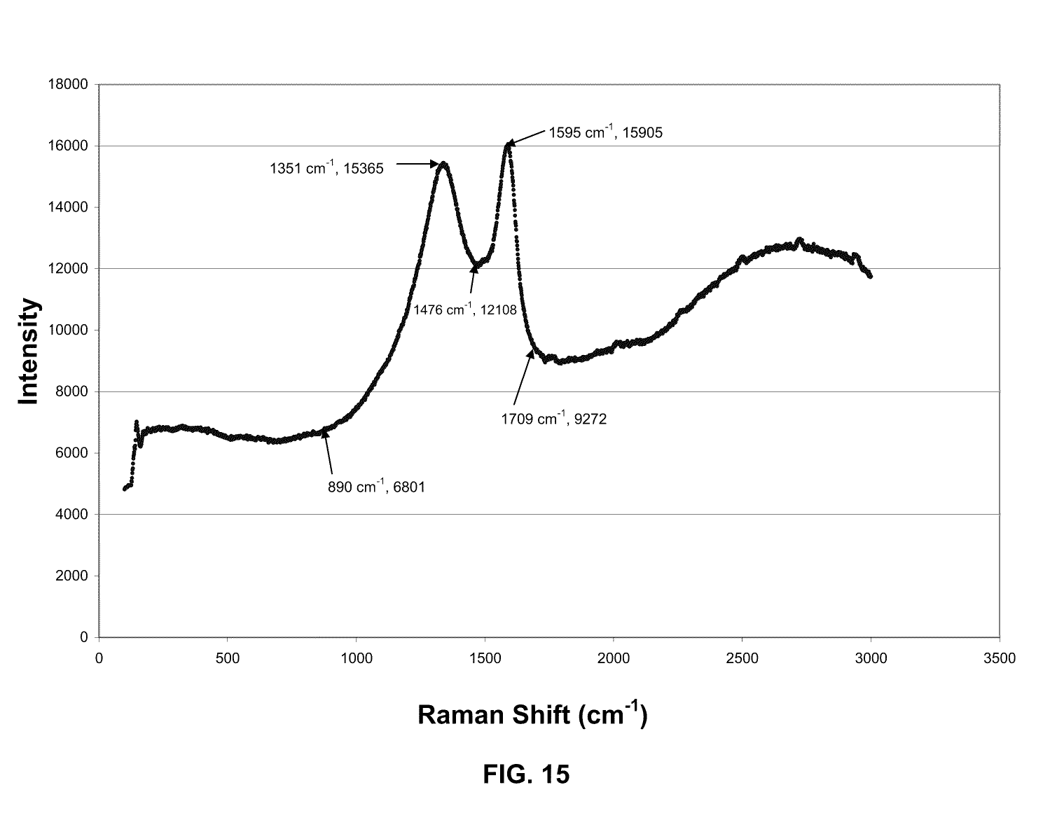

FIG. 15 shows a typical Raman spectroscopic data of carbon produced according to another embodiment of the present invention from microwaving (in the absence of metal atoms or added carbon) the reaction product of tannin and nickel salt. The Raman spectrum shows a peak at 1595 cm⁻¹ which represents the G-band (from graphitic natured carbon) and is due to the E_{2g} mode (stretching) related to the sp² carbons. The diffuse band (D-band) occurs around 1351 cm⁻¹ and represents the A_{1g} mode (breathing) mode of sp² C atoms in rings. The measure of I_{G}/I_{D} intensity ratio is generally used as a measure of graphite ordering. The broad peak that shows a maximum around 2700 cm⁻¹ may be ascribed to the first overtone of the D band. The Raman spectrum shows that a unique carbon nanostructure is being produced by a method of the present invention.

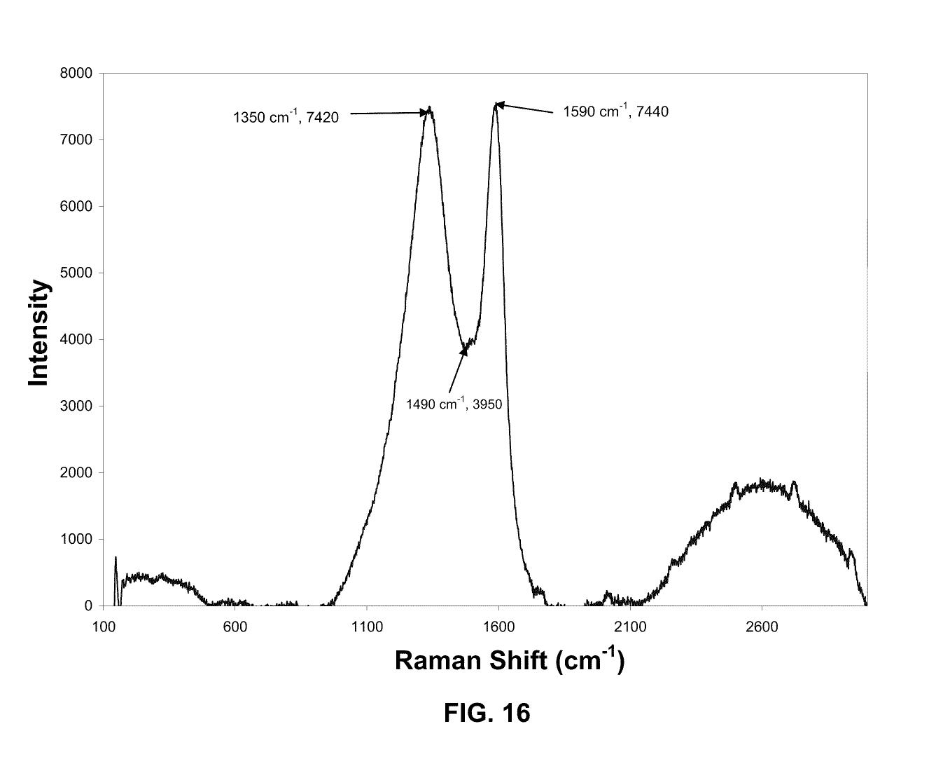

FIG. 16 shows a typical Raman spectroscopic data of carbon produced according to another embodiment of the present invention from microwaving (in the absence of metal atoms or added carbon) the reaction product of tannin and nickel salt. The baseline corrected Raman spectrum shows a peak at 1590 cm⁻¹ which represents the G-band (from graphitic natured carbon) is due to the E_{2g} mode (stretching) related to the sp² carbons. The diffuse band (D-band) occurs around 1350 cm⁻¹ and represents the A_{1g} mode (breathing) mode of sp² C atoms in rings. The measure of I_{G}/I_{D} intensity ratio is generally used as a measure of graphite ordering. The broad peak that shows a maximum around 2700 cm⁻¹ may be ascribed to the first overtone of the D band. The Raman spectrum shows that a unique carbon nanostructure is being produced by a method of the present invention.

### Example 7

This example describes nanodiamonds that are synthesized by microwaving the reaction product of tannin and formaldehyde, according to one embodiment of the present invention.

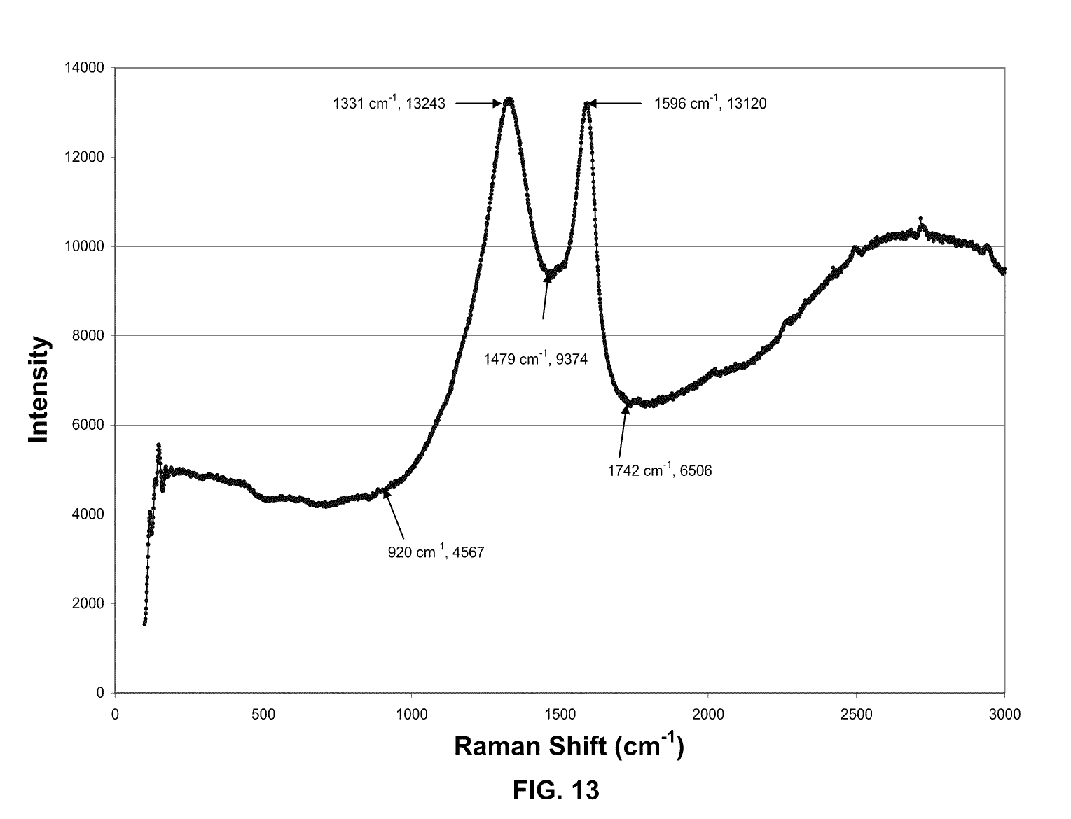

FIG. 13 shows a typical Raman spectroscopic data of carbon produced according to another embodiment of the present invention from microwaving (in the absence of metal atoms or added carbon) the reaction product of tannin and formaldehyde. The Raman spectrum shows a peak at 1596 cm⁻¹ representing the G-band (graphite) and is due to the E_{2g} mode (stretching) related to the sp² carbons. The diffuse band (D-band) occurs around 1331 cm⁻¹ and represents the A_{1g} mode (breathing) of sp² carbons in rings and may be associated with C atoms in nanodiamond. The broad peak that shows a maximum around 2700 cm⁻¹ may be ascribed to the first overtone of the D band. The Raman spectrum shows that a unique carbon nanostructure is being produced by a method of the present invention.

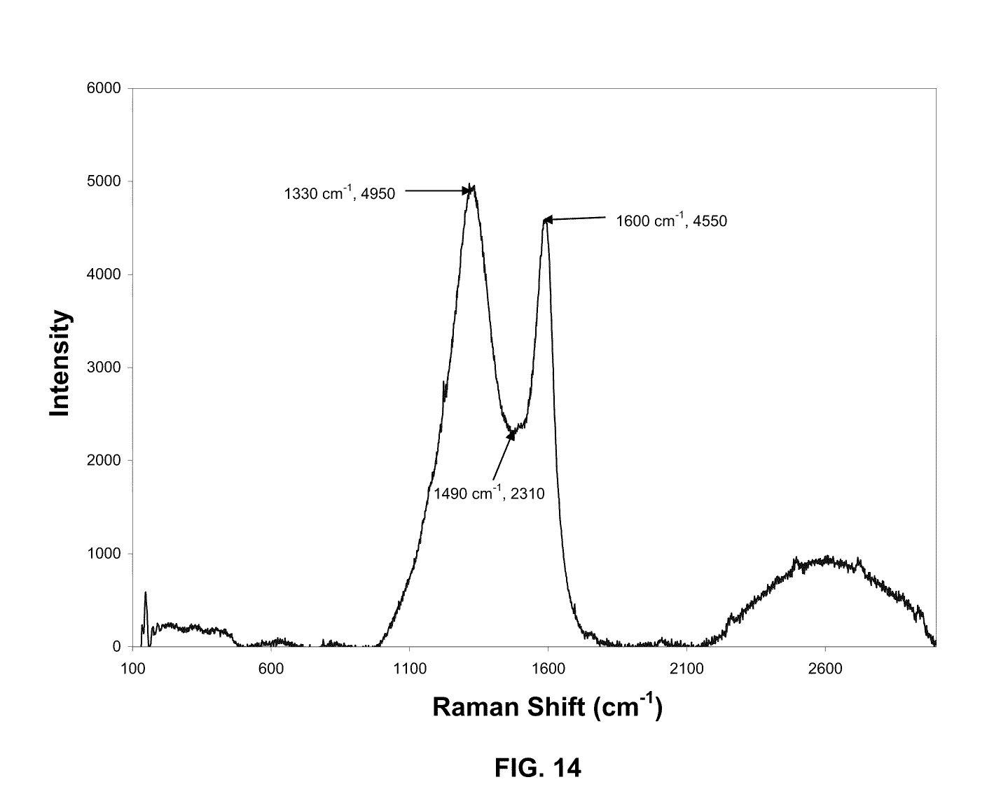

FIG. 14 shows a typical Raman spectroscopic data of carbon produced according to another embodiment of the present invention from the reaction product of tannin and formaldehyde (in the absence of metal atoms or added carbon). The baseline corrected Raman spectrum shows a peak at 1600 cm⁻¹ which represents the G-band (graphite) is due to the E_{2g} mode (stretching) related to the sp² carbons. The diffuse band (D-band) occurs around 1330 cm⁻¹ and represents the A_{1g} mode (breathing) and may be associated with C atoms in nanodiamond. The broad peak that shows a maximum around 2700 cm⁻¹ may be ascribed to the first overtone of the D band. The Raman spectrum shows that a unique carbon nanostructure is being produced by a method of the present invention.

### Example 8

This example describes nanodiamonds that are synthesized by microwaving the reaction product of lignosulfonate and ferric iron, according to one embodiment of the present invention.

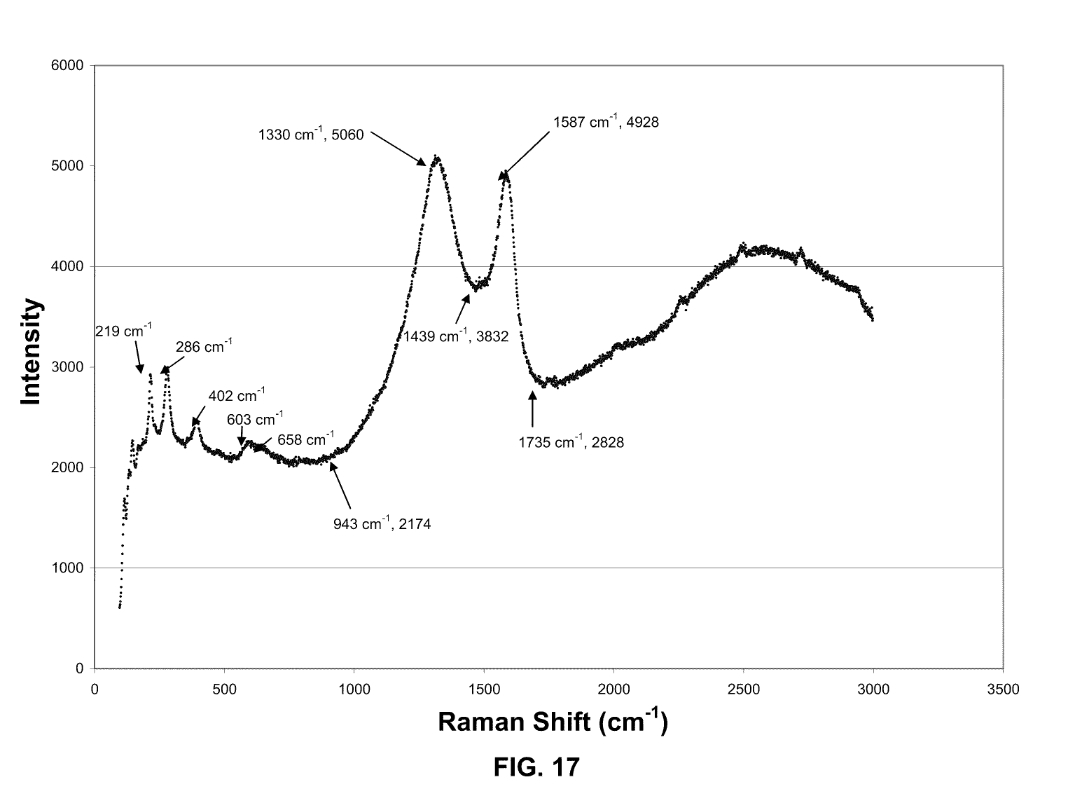

FIG. 17 shows a typical Raman spectroscopic data of carbon produced according to another embodiment of the present invention from microwaving (in the absence of metal atoms or added carbon) the reaction product of lignosulfonate and ferric iron. The Raman spectrum shows a peak at 1587 cm⁻¹ which represents the G-band (from graphitic natured carbon) and is due to the E_{2g} mode (stretching) related to the sp² carbons. The diffuse band (D-band) occurs around 1330 cm⁻¹ and may be associated with C atoms in nanodiamond. The broad peak that shows a maximum around 2700 cm⁻¹ may be ascribed to the first overtone of the D band. The Raman spectrum shows that a unique carbon nanostructure is being produced by a method of the present invention. Peaks below 1000 cm⁻¹ arise from iron-oxygen bonds.

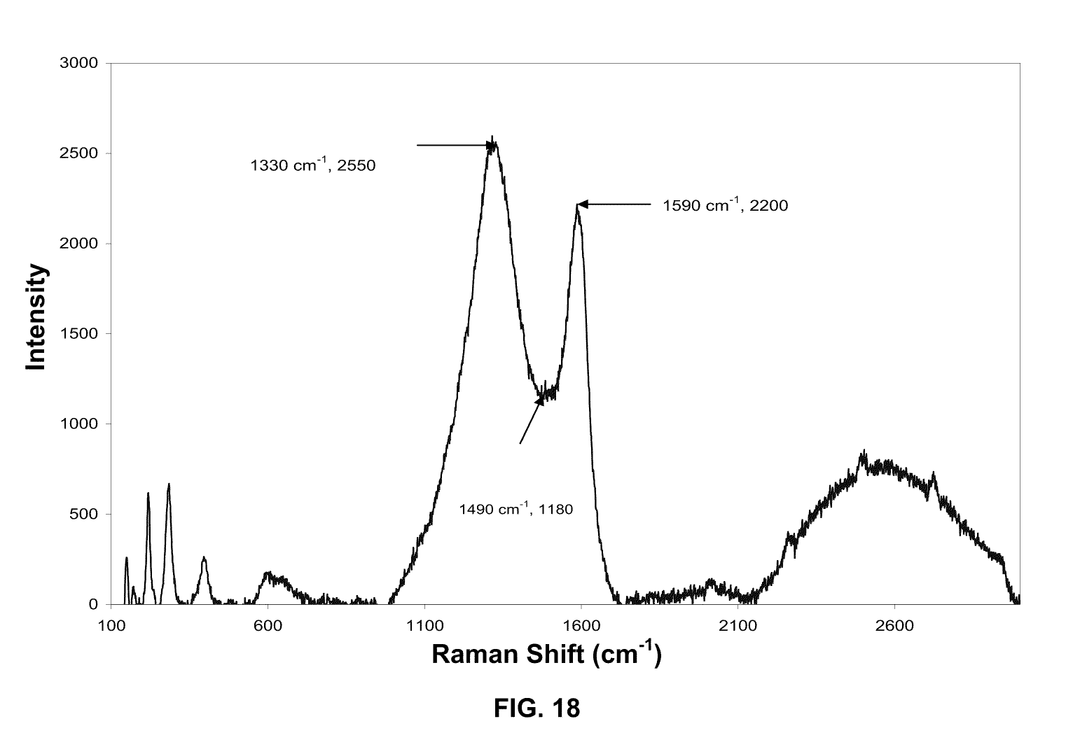

FIG. 18 shows a typical Raman spectroscopic data of carbon produced according to another embodiment of the present invention from microwaving (in the absence of metal atoms or added carbon) the reaction product of lignosulfonate and ferric iron. The Raman spectrum shows a peak at 1590 cm⁻¹ which represents the G-band (from graphitic natured carbon) and is due to the E_{2g} mode (stretching) related to the sp² carbons. The diffuse band (D-band) occurs at 1330 cm⁻¹ and may be associated with C atoms in nanodiamond. The broad peak that shows a maximum around 2700 cm⁻¹ may be ascribed to the first overtone of the D band. The Raman spectrum shows that a unique carbon nanostructure is being produced by a method of the present invention. Peaks below 1000 cm⁻¹ arise from iron-oxygen bonds.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### LIST OF REFERENCES

1. Sebastian Osswald,^{\} Gleb Yushin,^{\} Vadym Mochalin,^{\} Sergei O. Kucheyev,^{\} and Yury Gogotsi,*^{\} Control of sp²/sp³ Carbon Ratio and Surface Chemistry of Nanodiamond Powders by Selective Oxidation in Air, J. Am. Chem. Soc., 2006, 128 (35), pp 11635-11642.
2. Baker, Frederick S, Activated carbon fibers and engineered forms from renewable resources, US Patent Application Publ. (2007) 6 pp. US 2007142225 A1 20070621.
3. Wang, Tonghua; Tan, Suxia; Pan, Yanqiu; Qiu, Jieshan, Activated carbon preparation from biomass and waste plant materials by microwave heating, Faming Zhuanli Shenqing Gongkai Shuomingshu, (2006), 8 pp., CODEN: CNXXEV CN 1876566 A 20061213, patent written in Chinese, Application No: CN 1020-270-20060324.

What is claimed is:

1. A method of synthesizing nanodiamonds, comprising the step of:
subjecting an amount of tannin to a microwave radiation for a duration of time effective to produce a plurality of nanodiamonds.

2. The method of claim 1, wherein the frequency of the microwave radiation is about 2.45 GHz.

3. The method of claim 1, prior to the subjecting step, further comprising the steps of:
(a) placing the amount of tannin in a first container; and
(b) placing the first container with the amount of tannin in a second container that contains graphite or carbon black.

4. The method of claim 3, wherein the step of subjecting comprises the step of subjecting the amount of the tannin placed in the first container to the microwave radiation, wherein the first container is placed in the second container, which is positioned such that at least part of the graphite or carbon black contained in the second container is also subjected to the microwave radiation.

5. The method of claim 1, wherein the tannin is Quebracho tannin.

6. The method of claim 5, wherein the tannin is unmodified and hot water-soluble.

7. An article of manufacture made by the method of claim 1.

8. A method of synthesizing nanodiamonds, comprising the step of:
subjecting an amount of material selected from the group consisting of lignin, tannin, lignosulfonate, tanninsulfonate, and a mixture of thereof to a microwave radiation for a first duration of time effective to produce a sample containing a plurality of nanodiamonds.

9. The method of claim 8 further comprising the steps of:
(a) after the subjecting step, mixing the sample with water to obtain a solution;
(b) heating the solution to a first temperature for a second duration of time; and
(c) cooling the solution at a second temperature that is lower than the first temperature.

10. The method of claim 9, wherein the first temperature is corresponding to the boiling point of the solution, and the second temperature is room temperature.

11. The method of claim 10, wherein the first duration of time is less than 20 minutes for about 1 g of the material, and the second duration of time is same or different from the first duration of time.

12. The method of claim 8, prior to the subjecting step, further comprising the steps of:
(a1) placing the amount of material in a first container; and
(a2) placing the first container with the amount of the material in a second container.

13. The method of claim 8, wherein the frequency of the microwave radiation is about 2.45 GHz.

14. An article of manufacture made by the method of claim 8.

15. A method of synthesizing nanodiamonds, comprising the steps of:
(a) mixing a first amount of tannin with a second amount of sodium perborate (NaBO₃) to obtain a mixture; and
(b) subjecting the mixture to a microwave radiation for a first duration of time effective to produce a sample containing a plurality of nanodiamonds.

16. The method of claim 15, prior to the subjecting step, further comprising the steps of:
(a1) placing the mixture in a first container; and
(a2) placing the first container with the mixture in a second container that contains graphite or carbon black.

17. The method of claim 16, wherein the step of subjecting comprises the step of subjecting the mixture placed in the first container to the microwave radiation, wherein the first container is placed in the second container, which is positioned such that at least part of the graphite or carbon black contained in the second container is also subjected to the microwave radiation.

18. The method of claim 15, wherein the frequency of the microwave radiation is about 2.45 GHz.

19. The method of claim 15, wherein the tannin is Quebracho tannin.

20. The method of claim 19, wherein the tannin is unmodified and hot water-soluble.

21. The method of claim 15 further comprising the steps of:
(b1) after the subjecting step, mixing the sample with water to obtain a solution; and
(b2) heating the solution to a temperature corresponding to the boiling point of the solution for a second duration of time.

22. The method of claim 21, for about 1 g of tannin and about 0.1 g of sodium perborate and the power of the microwave radiation about 650 Watt, wherein the first duration of time is about 4 minutes.

23. The method of claim 22, wherein the second duration of time is different from the first duration of time.

24. An article of manufacture made by the method of claim 15.
